(19) United States
(12) Patent Application Publication
(10) Pub. No.: US 2016/0201381 A1
(43) Pub. Date: Jul. 14, 2016

(54) SPACER FOR INSULATING GLAZING UNITS

(71) Applicant: SAINT-GOBAIN GLASS FRANCE, Courbevoie (FR)

(72) Inventors: Hans-Werner KUSTER, AACHEN (DE); Walter SCHREIBER, AACHEN (DE); Martin RIGAUD, PFUNGEN (CH)

(21) Appl. No.: 14/909,073

(22) PCT Filed: Aug. 22, 2014
(86) PCT No.: PCT/EP2014/067901

§ 371 Date: Jan. 29, 2016

(30) Foreign Application Priority Data
Sep. 30, 2013 (EP) 13186710.3

(51) Int. Cl. E06B 3/663; E06B 3/677

(52) U.S. Cl. CPC E06B 3/66361; E06B 3/66304; E06B 3/6775

(57) ABSTRACT

A spacer for an insulating glazing unit composed of at least two glass panes is described. The spacer includes a polymeric basic body having at least two mutually parallel side walls which are connected to one another by an inner wall and an outer wall, wherein the side walls, the inner wall and the outer wall enclose a hollow chamber. The spacer further includes an insulation film on at least the outer wall. The insulation film contains a polymeric carrier film and at least one metallic or ceramic layer, wherein a reinforcing strip is incorporated in each side wall and contains at least one metal or a metallic alloy.

The invention relates to a spacer for insulating glazing units, a method for its production, its use, and an insulating glazing unit.

In the window and façade region of buildings, insulating glazing units are almost exclusively used nowadays. Insulating glazing units consist for the most part of two glass panes, which are arranged at a defined distance from each other by means of a spacer. The spacer is arranged peripherally in the edge region of the glazing unit. An intermediate space, which is usually filled with an inert gas, is thus formed between the panes. The flow of heat between the interior space delimited by the glazing unit and the external environment can be significantly reduced by the insulating glazing unit compared to a simple glazing.

The spacer has a non-negligible influence on the thermal properties of the pane. Conventional spacers are made of a light metal, customarily aluminum. These can be easily processed. The spacer is typically produced as a straight continuous profile, which is cut to the necessary size and then brought by bending into the rectangular shape necessary for use in the insulating glazing unit. Due to the good thermal conductivity of the aluminum, the insulating effect of the glazing unit is, however, significantly reduced in the edge region (cold edge effect).

In order to improve the thermal properties, so-called “warm edge” solutions for spacers are known. The spacers are made in particular of plastic and, consequently, have significantly reduced thermal conductivity. Plastic spacers are known, for example, from DE 27 52 542 C2 or DE 19 625 845 A1. However, in terms of processing, the plastic spacers have disadvantages. They can, for example, certainly be produced as endless profiles, but the subsequent bending requires local heating of the material, which is not simple to realize with conventional machines. Such profiles thus make significant investments necessary for the manufacturer of insulating glazing units.

DE 10 2010 006 127 A1 proposes improving the plastic spacer with a metallic foil to improve bendability. The metallic foil is arranged in particular on the surfaces turned toward the glass panes and the surface of the spacer turned away from the interpane space situated therebetween. The improvement of the bending properties is, however, accompanied by a worsening of the thermal properties because the metallic foil acts as a thermal bridge. The thermal advantages of the plastic spacer are, consequently, canceled out to a certain extent.

From DE 198 07 454 A1, a plastic spacer is known, in whose side walls perforated metal strips are embedded. The perforated metal strips serve to stiffen the spacer. The effects of the perforated metal strips on bendability as well as the accompanying requirements on the material of the spacer are not discussed.

There thus exists a need for spacers for insulating glazing units, which ensure minimal thermal conductivity and are nevertheless simple to process, in particular, are bendable. The object of the present invention is to provide such a spacer.

The object of the invention is accomplished according to the invention by a spacer for an insulating glazing unit in accordance with independent claim 1. Preferred embodiments emerge from the subclaims.

The spacer according to the invention for an insulating glazing unit composed of at least two glass panes comprises at least one polymeric basic body. The polymeric basic body comprises at least two mutually parallel side walls, which are intended to be turned toward the glass panes and to be brought into contact with the glass panes, and which are connected to each other by an inner wall and an outer wall. The side walls, the inner wall, and the outer wall surround a hollow chamber. Such a hollow chamber is customary for spacers and is intended, in particular, to accommodate a desiccant.

A reinforcing strip is preferably embedded in each side wall of the polymeric basic body. The reinforcing strip preferably contains at least one metal or one metallic alloy. In the context of the invention, “embedded” means that the reinforcing strip is completely surrounded by the material of the polymeric basic body or of the side walls of the polymeric basic body.

The reinforcing strips give the spacer the necessary bendability to be processed even with conventional industrial systems. The spacer can be bent into its final shape without having to be previously heated. By means of the reinforcing strips, the shape remains durably stable. In addition, the reinforcing strip increases the stability of the spacer. The reinforcing strips do not, however, act as a thermal bridge such that the properties of the spacer with regard to thermal conduction are not substantially adversely affected. There are, in particular, two reasons for this: (a) the reinforcing strips are embedded in the polymeric basic body, thus have no contact with the environment; (b) the reinforcing strips are arranged in the sidewalls and not, for example, in the outer wall or the inner wall, via which the heated exchange between the interpane space and the external environment occurs. The simultaneous realization of bendability and optimum thermal properties is the key advantage of the present invention.

The inventors have, moreover, found that bendability is a function of the glass fiber content of the polymeric basic body. The glass fiber content is, in conventional polymeric spacers made of glass fiber reinforced plastic, roughly 35 wt.-%. By means of this glass fiber content, adequate stability of the spacer is obtained. However, the spacer with such a high glass fiber content is too stiff to be able to be bent without damage. The inventors have found that a glass fiber content of at most 20 wt.-% enables good bendability. The decreased stiffness and stability accompanying the reduced glass fiber content, in particular even against restoring forces after bending, is compensated by the reinforcement profiles according to the invention.

The reinforcing strips according to the invention, in conjunction with the low glass fiber content of the polymeric basic body according to the invention thus enable good bendability with simultaneously higher stability and stiffness in the installed position.

The other sections of the basic body other than the side walls, in particular the inner wall and the outer wall, preferably have no metallic inserts.

The thermal conductivity (λ-value) of the spacer is preferably less than 0.25 W/(m*K), particularly preferably less than 0.2 W/(m*K). This means the thermal conductivity measured for the entire spacer (equivalent thermal conductivity) without taking into account local fluctuations of the thermal conductivity as a function of the precise position on the spacer. It is surprising to obtain such low thermal conductivities through a polymeric basic body with the reinforcing profile according to the invention.

The side walls of the polymeric basic body are intended to face the glass panes in the finished insulating glazing unit. The contact of the spacer with the glass panes is done by the side walls. There need be no direct contact between the spacer and the pane. Instead, the contact can be made directly, for example, via a sealing compound.

The inner wall is intended to face the intermediate space between the glass panes in the finished insulating glazing unit. The inner wall is, in an advantageous embodiment, provided with holes to ensure the action of a desiccant in the hollow chamber on the intermediate space.

The outer wall is situated opposite the inner wall and is intended to face the external environment of the insulating glazing unit. The outer wall points outward from the intermediate space between the glass panes, in which the spacer is arranged.

The side walls, the outer wall, and the inner wall, and, optionally, the connection sections preferably have in each case a thickness (material thickness) from 0.5 mm to 2 mm, particularly preferably from 0.8 mm to 1.5 mm. The thickness of the polymeric basic body is preferably constant, in other words, all walls and sections have the same thickness. Such a spacer is simple to process and advantageously stable.

The inner wall, the outer wall, and the side walls are, in a preferred embodiment, implemented flat in each case. The inner wall, the outer wall, and the side walls are thus, in this context, flat sections of the polymeric basic body. Each wall is connected on its ends to the respective ends of the two adjacent walls. The side walls can be directly connected to the inner wall and the outer wall.

In a preferred embodiment, the inner wall is connected directly to the side walls, whereas the outer wall is indirectly connected to the side walls, i.e., via connection sections. The connection sections are preferably also implemented flat. The inner wall is preferably arranged at an angle of roughly 90° relative to each side wall. The side walls are parallel to each other and the inner wall is parallel to the outer wall. The connection sections are preferably arranged at an angle from 120° to 150°, ideally 135° relative to each side wall. This shape for the spacer has proved itself particularly suitable.

The width of the polymeric basic body is preferably from 5 mm to 35 mm, particularly preferably from 5 mm to 33 mm, for example, from 10 mm to 20 mm. The width is, in the context of the invention, the dimension extending between the sidewalls. The width is the distance between the surfaces of the two sidewalls turned away from each other. The width of the basic body defines the distance between the two glass panes in the insulating glazing unit.

The height of the polymeric basic body is preferably from 3 mm to 20 mm, particularly preferably from 5 mm to 10 mm, and most particularly preferably from 5 mm to 8 mm. In this range for the height, the spacer has advantageous stability but is, on the other hand, advantageously inconspicuous in the insulating glazing unit. Moreover, the hollow chamber of the spacer has an advantageous size to accommodate a suitable amount of desiccant.

The height is the distance between the surfaces of the outer wall and of the inner wall turned away from each other.

The polymeric basic body preferably contains at least polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), acrylonitrile-butadiene-styrene (ABS), acrylonitrile styrene acrylester (ASA), acrylonitrile-butadiene-styrene/polycarbonate (ABS/PC), styrene acrylonitrile (SAN), polyethylene terephthalate/polycarbonate (PET/PC), polybutylene terephthalate/polycarbonate (PBT/PC), or copolymers or derivatives or mixtures thereof. The polymeric basic body particularly preferably contains polypropylene (PP), acrylonitrile-butadiene-styrene (ABS), acrylonitrile styrene acrylester (ASA), acrylonitrile butadiene styrene/polycarbonate (ABS/PC), styrene acrylonitrile (SAN), polyethylene terephthalate/polycarbonate (PET/PC), polybutylene terephthalate/polycarbonate (PBT/PC) or copolymers or derivatives or mixtures thereof. These materials are particularly advantageous with regard to low thermal conductivity and good processing.

The polymeric basic body preferably has a glass fiber content from 0 wt.-% to 20 wt.-%, particularly preferably from 0 wt.-% to 15 wt.-%. Compared to polymeric spacers according to the prior art, which, as a rule, have a glass fiber content of roughly 35 wt.-%, the glass fiber content is low. As a result, the stiffness and stability of the spacer is, to be sure, reduced; however, the bendability is advantageously improved. The reduced stability, in particular even against restoring forces after bending, is compensated by the reinforcement profiles according to the invention.

In an advantageous embodiment, the glass fiber content is 0 wt.-%; the polymeric basic body thus contains no glass-fiber-reinforced plastic. In another advantageous embodiment, the polymeric basic body contains glass-fiber-reinforced plastic, wherein the glass fiber content is less than 20 wt.-%, preferably less than 15 wt.-%. By means of a glass fiber content, the coefficient of thermal expansion of the basic body in particular can be varied and adapted.

The reinforcing strip according to the invention contains, in a preferred embodiment, at least steel. Steel is readily available, readily processable, and gives the spacer particularly advantageous bendability and also improves stability and stiffness. The steel is, particularly preferably, not stainless steel, which is particularly advantageous with regard to the costs for the spacer. Corrosion of the steel is prevented by its embedding in the polymeric basic body.

The reinforcing strip preferably has a thickness from 0.05 mm to 1 mm, particularly preferably from 0.1 mm to 0.5 mm, most particularly preferably from 0.2 mm to 0.4 mm, in particular from 0.25 mm to 0.35 mm. In a particularly preferred embodiment, the thickness of the reinforcing strip is roughly 0.3 mm. Thus, particularly good results are obtained with regard to the bendability, stiffness, and stability of the spacer.

The reinforcing strip preferably has a width from 1 mm to 5 mm. Thus, good bendability and stiffening are obtained. The width of the reinforcing strip is, of course, in the individual case, also a function of the width of the side wall.

The length of the reinforcing strip preferably corresponds to the length of the polymeric basic body.

In one embodiment of the invention, the reinforcing strip can be perforated. As a result of suitable perforation, the bendability can be advantageously influenced.

In an advantageous embodiment, the reinforcing strip is bonded to the polymeric basic body via an adhesion promoter. Each contact surface between the reinforcing strip and the basic body is preferably provided with the adhesion promoter. This is particularly advantageous for the adhesion between a polymeric basic body and a reinforcing strip and, thus, for the stability of the spacer.

In a preferred embodiment of the invention, the spacer is provided with an insulation film. The insulation film further reduces the thermal conductivity of the spacer. The insulation film also prevents diffusion through the spacer. Thus, in particular, penetration of moisture into the interpane space and the loss of an inert gas from the interpane space are prevented. The insulation film preferably has gas permeation of less than 0.001 g/(m² h).

The insulation film is arranged at least on the outer surface of the outer wall. In the context of the invention, “outer surface” designates the surface of a wall facing away from the hollow chamber. Preferably, the insulation film is arranged at least on the outer surface of the entire section of the basic body including the outer wall of the basic body between the side walls. If the outer wall is connected to the side walls, for example, via, in each case, a connection section, the insulation film is arranged on the outer surfaces of the outer wall and of the two connection sections. In a particularly advantageous embodiment, the insulation film is arranged on the outer surface of the section of the basic body including the outer wall between the side walls and, additionally, at least on the outer surface of at least one section of each side wall. The insulation film thus extends from the first side wall over the outer wall (and, optionally, connection sections) to the opposite side wall. Thus, particularly good results are obtained with regard to the stability of the assembly of the polymeric basic body and the insulation film as well as with regard to the thermal properties of the spacer.

The insulation film contains at least one polymeric film. The polymeric film serves as a carrier film and preferably has a thickness from 10 μm to 100 μm, particularly preferably from 15 μm to 60 μm, which is advantageous for the stability of the insulation film.

The insulation film also contains at least one metallic or ceramic layer, which is applied on the carrier film. The thickness of the metallic or ceramic layer is preferably from 10 nm to 1500 nm, particularly preferably from 10 nm to 400 nm, most particularly preferably from 30 nm to 200 nm. Thus, particularly good results are obtained with regard to the insulation effect.

The insulation film preferably contains at least one other polymeric layer, whose thickness is preferably from 5 μm to 100 μm, particularly preferably from 15 μm to 60 μm.

In a particularly preferred embodiment, the polymeric carrier film and the polymeric layer are made of the same material. This is particularly advantageous since lower diversity of materials used simplifies the production cycle. The polymeric film and the polymeric layer or the polymeric layers preferably have the same material thickness such that the same starting material can be used for all polymeric components of the insulation film.

The polymeric film and/or the polymeric layer preferably contains at least polyethylene terephthalate, ethylene vinyl alcohol, polyvinylidene chloride, polyamides, polyethylene, polypropylene, silicones, acrylonitriles, polymethyl acrylates, or copolymers or mixtures thereof.

A metallic layer preferably contains iron, aluminum, silver, copper, gold, chromium, or alloys or mixtures thereof.

A ceramic layer preferably contains silicon oxide and/or silicon nitride.

The insulation film preferably contains at least two metallic or ceramic layers, with at least one polymeric layer arranged in each case between two adjacent metallic or ceramic layers. This is particularly advantageous for the insulating effect of the polymeric film, in particular since possible defects within one layer can be compensated for by one of the other layers. In addition, compared to a single thick layer, multiple thin layers have better adhesion properties. Preferably, the uppermost layer of the insulation film is a polymeric layer, which serves to protect the metallic or ceramic layers. The uppermost layer is the layer that is the greatest distance from the polymeric carrier film. The insulation film has, in a particularly advantageous embodiment, from two to four metallic or ceramic layers. The metallic or ceramic layers are preferably arranged alternatingly with at least one polymeric layer in each case.

The invention further comprises an insulating glazing unit, comprising at least two glass panes arranged parallel to each other and a spacer according to the invention arranged in the edge region between the glass panes. The spacer is preferably implemented in the form of a peripheral frame. Each side wall faces one of the glass panes and is brought into contact with the respective glass pane. The side walls of the spacer are preferably bonded to the glass panes via a sealing layer. Butyl is, for example, suitable as the sealing layer. An external sealing compound is arranged at least on the outer wall of the spacer, preferably in the edge space between the panes and the spacer. The external, preferably plastic sealing compound contains, for example, polymers or silane-modified polymers, particularly preferably organic polysulfides, silicones, RTV (room temperature vulcanizing) silicone rubber, HTV (high temperature vulcanizing) silicone rubber, peroxide vulcanizing silicone rubber, and/or addition vulcanizing silicone rubber, polyurethanes, butyl rubber, and/or polyacrylates.

The interpane space is preferably evacuated or filled with an inert gas, for example, argon or krypton.

The hollow chamber of the spacer is preferably completely or partially filled with a desiccant. Residual moisture in the interpane space is absorbed by the desiccant such that the panes cannot fog. Silica gels, molecular sieves, CaCl₂, Na₂SO₄, activated carbon, silicates, bentonites, and/or zeolites are, in particular, suitable as the desiccant.

The insulating glazing unit preferably has a Psi value of less than 0.05 W/(m*K), preferably less than 0.035 W/(m*K). The Psi value is measured as thermal conductivity on the insulating glass with a frame system.

The glass panes are preferably made of soda lime glass. The thickness of the panes can, in principle, be varied at will; a thickness from 1 mm to 25 mm, preferably from 3 mm to 19 mm is, in particular, common. The transparency of the panes is preferably greater than 85%.

The insulating glazing unit can, of course, also include more than two glass panes, with a spacer according to the invention preferably arranged in each case between two adjacent glass panes.

The object of the invention is further accomplished according to the invention by a method for producing a spacer according to the invention for an insulating glazing unit, wherein

a) two reinforcing strips are arranged parallel to each other,
b) the reinforcing strips are overmolded with a polymeric material, wherein the polymeric basic body is created,
c) an insulation film is applied at least on the outer wall of the basic body,
d) the polymeric basic body with the reinforcing strips is cut to size, and
e) the polymeric basic body with the reinforcing strips is bent into a peripheral frame form.

The polymeric basic body with the reinforcing strips is produced by extrusion as an endless profile. From this endless profile, a profile section is cut to size with the length required for use in the insulating glass. The profile section has a first and a second end. The profile section is then bent into the peripheral, customarily rectangular frame form. The ends are preferably connected to each other, for example, by a push-in connection in order to improve the stability of the frame form.

The hollow chamber of the spacer is preferably filled with a desiccant. The desiccant can, alternatively, also be extruded together with the basic body.

The bending of the profile section is preferably done without prior heating, in particular at ambient temperature. It is a particular advantage of the spacer with the reinforcing strip according to the invention that such heating is not required. Thus, the spacer can be processed on conventional industrial production systems.

In a preferred embodiment, the polymeric basic body is provided with an insulation film according to the invention. Preferably, this is done before the bending of the spacer. The insulation film can, for example, be applied on the basic body by gluing or can even be extruded together with the basic body.

The insulating glass according to the invention is produced in that the frame-shaped spacer is arranged in the edge region between two parallel glass panes. The glass panes are bonded to the spacer, preferably by pressing and via a sealing layer in each case. Subsequently, an external sealing compound is arranged at least on the outer wall. Preferably, the edge space between the panes and the spacer is peripherally filled with the external sealing compound.

The intermediate space between the glass panes delimited by the frame-shaped spacer is preferably subjected to negative pressure and/or filled with an inert gas.

The invention further comprises the use of the spacer according to the invention in multipane glazing units, preferably in insulating glazing units. The insulating glazing units are preferably used as window glazing units or façade glazing units of buildings.

In the following, the invention is explained in detail with reference to drawings and exemplary embodiments. The drawings are a schematic representation and not true to scale. The drawings in no way restrict the invention.

They depict:

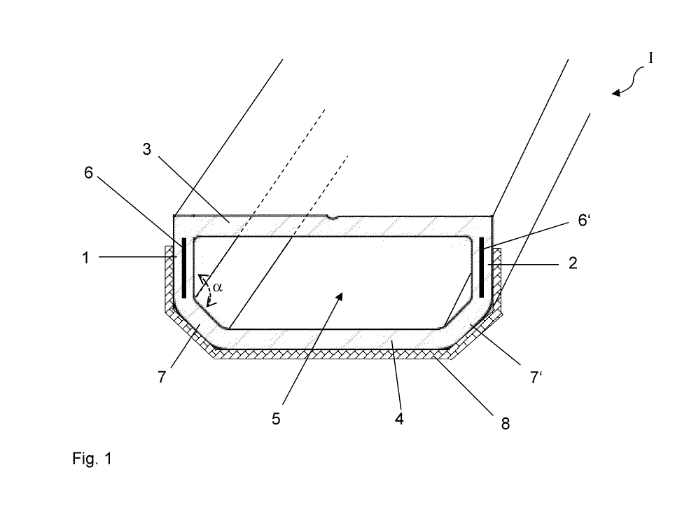

FIG. 1 a perspective cross-section through an embodiment of the spacer according to the invention,

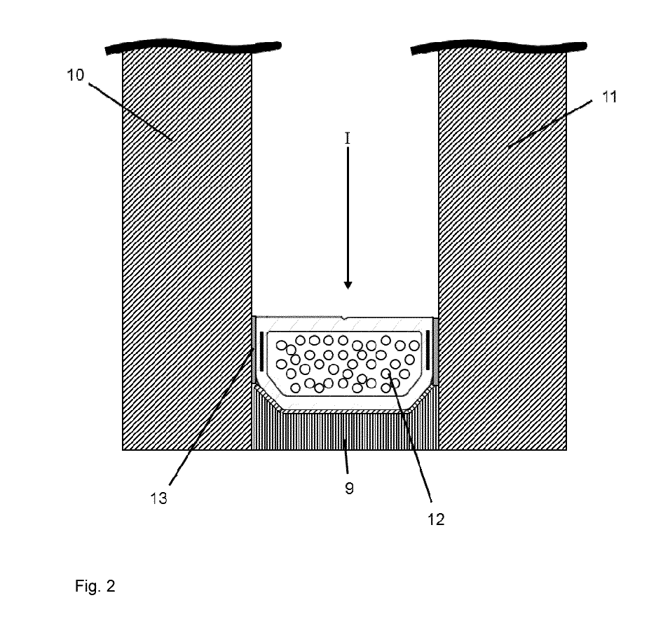

FIG. 2 a cross-section through an embodiment of the insulating glazing unit according to the invention with the spacer according to the invention, and

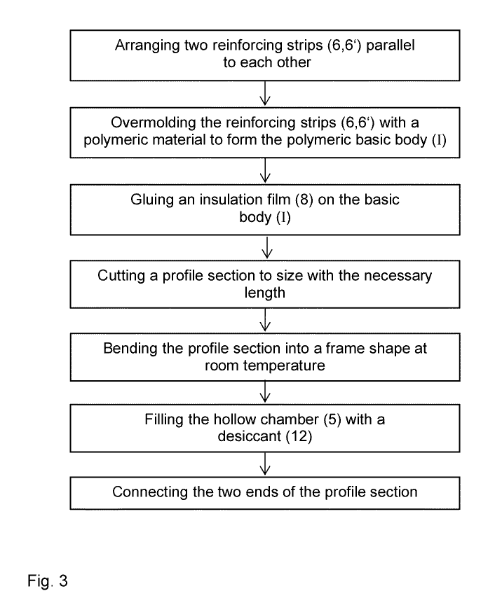

FIG. 3 a flowchart of an embodiment of the method according to the invention.

FIG. 1 depicts a cross-section through a spacer according to the invention for an insulating glazing unit. The spacer comprises a polymeric basic body I, made, for example, of polypropylene (PP). The polymer has a glass fiber content of 0 wt.-% or a relatively low glass fiber content of, for example, 10 wt.-%.

The basic body I comprises two parallel side walls 1, 2, which are intended to be brought into contact with the panes of the insulating glass. In each case between one end of each side wall 1, 2 runs an inner wall 3 that is intended to face the interpane space of the insulating glass. On the other ends of the side walls 1, 2, a connection section 7, 7′ is in each case connected. Via the connection sections 7, 7′, the side walls 1, 2 are connected to an outer wall 4, which is implemented parallel to the inner wall 3. The angle a between the connection sections 7 (or 7′) and the side wall 3 (or 4) is roughly 45°. The result of this is that the angle between the outer wall 4 and the connection sections 7, 7′ is also roughly 45°. The basic body I surrounds a hollow chamber 5.

The material thickness (thickness) of the side walls 1, 2, of the inner wall 3, of the outer wall 4, and of the connection sections 7, 7′ is roughly the same and is, for example, 1 mm. The basic body has, for example, a height of 6.5 mm and a width of 15 mm.

A reinforcing strip 6 is embedded in each side wall 1, 2. The reinforcing strips 6, 6′ are made of steel, which is not stainless steel, and they have a thickness (material thickness) of, for example, 0.3 mm and a width of, for example, 3 mm. The length of the reinforcing strips 6, 6′ corresponds to the length of the basic body I.

The reinforcing strips give the basic body I sufficient bendability and stability to be bent without prior heating and to durably retain the desired shape. In contrast to other solutions according to the prior art, the spacer here has very low thermal conductivity since the metallic reinforcing strips 6, 6′ are embedded only in the side walls 1,2, via which only a very small part of the heat exchange between the pane interior and the external environment occurs. The reinforcing strips 6, 6′ do not act as thermal bridges. These are major advantages of the present invention.

An insulation film 8 is arranged on the outer surface of the outer wall 4 and of the connection sections 7, 7′ as well as a section of the outer surface of each of the sidewalls 1, 2. The insulation film 8 reduces diffusion through the spacer. Thus, the entry of moisture into the interpane space of an insulating glazing unit or the loss of the inert gas filling of the interpane space can be reduced. Moreover, the insulation film 8 improves the thermal properties of the spacer, thus reduces thermal conductivity.

The insulation film 8 comprises the following layer sequence: a polymeric carrier film (made of LLDPE (linear low density polyethylene), thickness: 24 μm)/a metallic layer (made of aluminum, thickness: 50 nm)/a polymeric layer (PET, 12 μm)/a metallic layer (Al, 50 nm)/a polymeric layer (PET, 12 μm). The layer stack on the carrier film thus includes two polymeric layers and two metallic layers, with the polymeric layers and the metallic layers arranged alternatingly. The layer stack can also include other metallic layers and/or polymeric layers, with metallic and polymeric layers likewise preferably arranged alternatingly such that between two adjacent metallic layers, a polymeric layer is in each case arranged and a polymeric layer is arranged above the uppermost metallic layer.

By means of the assembly comprising a polymeric basic body I, the reinforcing strips 6,6′, and the insulation film 8, the spacer according to the invention has advantageous properties with regard to stiffness, leakproofness, and thermal conductivity. Consequently, it is suitable to a special extent for use in insulating glasses, in particular in the window or façade region of buildings.

FIG. 2 depicts a cross-section through an insulating glass according to the invention in the region of the spacer. The insulating glass is made of two glass panes 10, 11 of soda lime glass with a thickness of, for example, 3 mm, which are connected to each other via a spacer according to the invention arranged in the edge region. The spacer is the spacer in accordance with FIG. 1 with the reinforcing strips 6,6′ and the insulation film 8.

The side walls 1, 2 of the spacer are bonded to the glass panes 10, 11 via, in each case, a sealing layer 13. The sealing layer 13 is made, for example, of butyl. In the edge space of the insulating glass between the glass panes 10, 11 and the spacer, an external sealing compound 9 is arranged peripherally. The sealing compound 9 is, for example, a silicone rubber.

The hollow chamber 5 of the basic body I is filled with a desiccant 12. The desiccant 12 is, for example, a molecular sieve. The desiccant 12 absorbs residual moisture present between the glass panes and the spacer and thus prevents fogging of the panes 10, 11 in the interpane space. The action of the desiccant 12 is promoted by holes (not shown) in the inner wall 3 of the basic body I.

FIG. 3 depicts a flowchart of an exemplary embodiment of the method according to the invention for producing a spacer for an insulating glass.

### EXAMPLE

A spacer according to the invention in accordance with FIG. 1 was produced with the reinforcing strips 6, 6′ according to the invention and the insulation film 8. The spacer was produced as a straight profile and subsequently bent into the necessary shape for use in an insulating glazing unit. Then, it was evaluated whether the spacer had undergone damage as a result of the bending procedure which would preclude its use and whether it durably retains the desired shape. If the spacer underwent no damage and retained its shape, it was classified as “bendable”. Moreover, the thermal conductivity of the spacer (λ value) was measured. This was the equivalent thermal conductivity, i.e., a measurement for the entire spacer which disregards the location dependency of the thermal conductivity on the spacer. The results are summarized in Table 1.

### Comparative Example 1

Comparative Example 1 differed from the example according to the invention by the configuration of the spacer. Otherwise, Comparative Example 1 was carried out the same as the Example. The spacer in Comparative Example 1 had no reinforcing strips 6, 6′ embedded in the side walls. Moreover, the glass fiber content of the polymeric basic body I was 35 wt.-%. Apart from that, the spacer corresponded to that from FIG. 1. The results are summarized in Table 1.

### Comparative Example 2

Comparative Example 2 differed from the example according to the invention by the configuration of the spacer. Otherwise, Comparative Example 2 was carried out the same as the Example. The spacer in Comparative Example 2 had no reinforcing strips 6, 6′ embedded in the side walls. Instead, a stainless steel foil with a thickness of 0.1 mm was applied on the outer surface of the side walls, the connection sections, and the outer wall to provide the spacer according to the prior art with bendability. The glass fiber content of the polymeric basic body I was 35 wt.-%. The results are summarized in Table 1.

TABLE 1

| | Bendable? | Thermal Conductivity |
|---|---|---|
| Example | Yes | 0.18 W/(m * K) |
| Comparative | No | 0.16 W/(m * K) |
| Example 1 | | |
| Comparative | Yes | 0.30 W/(m * K) |
| Example 2 | | |

The spacer according to the invention in the Example was, in contrast to the spacer of Comparative Example 1, bendable because of the reinforcing strips 6,6′. The thermal conductivity was, however, only insignificantly increased by the reinforcing strips 6,6′. The spacer according to the invention in the Example had, in contrast to the spacer of the Comparative Example 2, significantly lower thermal conductivity. The reinforcing strips 6, 6′ according to the invention, which, in contrast to the stainless steel foil according to the prior art, do not serve as a thermal bridge, are the reason for this.

The spacer according to the invention thus combines sufficient bendability with very low thermal conductivity. This result was unexpected and surprising for the person skilled in the art.

### LIST OF REFERENCE CHARACTERS

(I) polymeric basic body
(1) side wall
(2) side wall
(3) inner wall
(4) outer wall
(5) hollow chamber
(6,6′) reinforcing strip
(7,7′) connection section
(8) insulation film
(9) external sealing compound
(10) glass pane
(11) glass pane
(12) desiccant
(13) sealing layer
α angle between side wall 1,2 and connection section 7,7′

1.-15. (canceled)

16. A spacer for an insulating glazing unit, comprising:
a polymeric basic body having a first side wall and a second side wall,
wherein the first side wall and the second side wall are formed parallel to each other,
wherein the first side wall and the second side wall are connected to each other by an inner wall and an outer wall,
wherein the first side wall, the second side wall, the inner wall, and the outer wall surround a hollow chamber, and
wherein the polymeric basic body has a glass fiber content from 0 wt.-% to 20 wt.-%;
an insulation film disposed on at least the outer wall, the insulation film containing a polymeric carrier film, the insulation film further containing a metallic layer or a ceramic layer;
a first reinforcing strip embedded in the first side wall, the first reinforcing strip containing a metal or a metallic alloy; and
a second reinforcing strip embedded in the second side wall, the second reinforcing strip containing a metal or a metallic alloy.

17. The spacer according to claim 16, wherein the first reinforcing strip and the second reinforcing strip each contain steel.

18. The spacer according to claim 17, wherein the steel in the first reinforcing strip and the second is not stainless steel.

19. The spacer according to claim 16, wherein the first reinforcing strip and the second reinforcing strip each has a thickness from 0.05 mm to 1 mm.

20. The spacer according to claim 16, wherein the first reinforcing strip and the second reinforcing strip each has a thickness from 0.1 mm to 0.5 mm.

21. The spacer according to claim 16, wherein the first reinforcing strip and the second reinforcing strip each has a thickness from 0.2 mm to 0.4 mm.

22. The spacer according to claim 16, wherein the first reinforcing strip and the second reinforcing strip each has a width from 1 mm to 5 mm.

23. The spacer according to claim 16, wherein the thickness of the polymeric carrier film of the insulation film is from 10 μm to 100 μm, wherein the thickness of the metallic or ceramic layer of the insulation film is from 10 nm to 1500 nm, and wherein the insulation film further contains at least one polymeric layer having a thickness from 5 μm to 100 μm.

24. The spacer according to claim 23, wherein the insulation film contains from two to four metallic layers or ceramic layers, which are in each case arranged alternatingly with at least one polymeric layer.

25. The spacer according to claim 23, wherein each metallic layer or ceramic layer of the insulation film contains iron, aluminum, silver, copper, gold, chromium, silicon oxide, silicon nitride, or alloys or mixtures thereof; and wherein the polymeric carrier film of the insulation film contains polyethylene terephthalate, ethylene vinyl alcohol, polyvinylidene chloride, polyamides, polyethylene, polypropylene, silicones, acrylonitriles, polymethyl acrylates, or copolymers or mixtures thereof.

26. The spacer according to claim 16, wherein the basic body contains polyethylene (PE), polycarbonates (PC), polystyrene, polybutadiene, polynitriles, polyesters, polyurethanes, polymethyl methacrylates, polyacrylates, polyamides, polyethylene terephthalate (PET), polybutylene terephthalate (PBT), preferably polypropylene (PP), acrylonitrile butadiene styrene (ABS), acrylonitrile styrene (ASA), acrylonitrile butadiene styrene/polycarbonate (ABS/PC), styrene acrylonitrile (SAN), polyethylene terephthalate/polycarbonate (PET/PC), polybutylene terephthalate/polycarbonate (PBT/PC), or copolymers or derivatives or mixtures thereof.

27. The spacer according to claim 16, wherein the polymeric basic body has a glass fiber content from 0 wt.-% to 15 wt.-%.

28. The spacer according to claim 16, wherein the first reinforcing strip is perforated and the second reinforcing strip is perforated.

29. The spacer according to claim 16,
wherein the first side wall, the second side wall, the inner wall, and the outer wall are each flat;
wherein the inner wall is directly connected to first side wall and the second side wall;
wherein the outer wall is connected via flat connection sections to the first side wall and the second side wall; and
wherein each flat connection section and each of the first side wall and the second side wall form an angle from 120° to 150°.

30. The spacer according to claim 16, wherein the spacer has thermal conductivity of less than 0.25 W/(m*K).

31. An insulating glazing unit, comprising:
a first glass pane and a second glass pane arranged parallel to each other; and
a spacer according to claim 16 arranged in an edge region between the first glass pane and the second glass pane, wherein the first side wall faces the first glass pane and the second side wall faces the second glass pane; and
an external sealing layer at least on the outer wall.

32. The insulating glazing unit according to claim 31, wherein the hollow chamber is completely filled or partially filled with a desiccant.

33. The insulating glazing unit according to claim 32, wherein the desiccant includes one or more of silica gels, molecular sieves, CaCl₂, Na₂SO₄, activated carbon, silicates, bentonites, and zeolites.

34. A method for producing a spacer for an insulating glazing unit, comprising:
forming a spacer according to claim 16, including
arranging the first reinforcing strip and the second reinforcing strip parallel to each other;
overmolding the first reinforcing strip and the second reinforcing strip each with a polymeric material, wherein the polymeric basic body is created with ends;
applying an insulation film at least on the outer wall of the polymeric basic body;
cutting the polymeric basic body to size;
bending the polymeric basic body into a peripheral frame form; and
connecting the ends of the polymeric basic body to each other.

35. A method of using a spacer in a multipane glazing unit, comprising:
providing a spacer according to claim 16; and
inserting the spacer in an insulating glazing unit.
